(19) United States
(12) Patent Application Publication
(10) Pub. No.: US 2026/0238010 A1
(43) Pub. Date: Aug. 13, 2026

(54) METHOD OF AUTOMATICALLY TUNING ASSET CONTROLLER OF ASSET ASSOCIATED WITH MICROGRID

(71) Applicant: Caterpillar Inc., Peoria, IL (US)

(72) Inventors: Sayandip Roy, Kolkata (IN); Ranjay Singh, Bangalore (IN); Bantupalli Manoj Kumar, Bangalore (IN); Guhan Sidharth M., Bengaluru (IN)

(73) Assignee: Caterpillar Inc., Peoria, IL (US)

(21) Appl. No.: 19/050,449

(22) Filed: Feb. 11, 2025

(51) Int. Cl. H02J 3/28

(52) U.S. Cl. CPC H02J 3/28; H02J 2103/30; H02J 2103/35

(57) ABSTRACT

A method of automatically tuning an asset controller of an asset associated with a microgrid includes receiving, by a microgrid controller, at least one input parameter from the asset controller. The method also includes determining, by the microgrid controller, a default output response based on the at least one input parameter. The method further includes receiving, by the microgrid controller, a current output response from the asset controller. The current output response is generated by the asset controller based on the at least one input parameter. The method includes comparing, by the microgrid controller, the current output response with the default output response. The method also includes generating, by the microgrid controller, at least one tunable parameter for the asset controller. The method further includes transmitting, by the microgrid controller, the at least one tunable parameter to the asset controller to automatically tune the asset controller.

### TECHNICAL FIELD

The present disclosure relates to a method of automatically tuning an asset controller of an asset associated with a microgrid. The present disclosure further relates to a microgrid controller associated with the microgrid.

### BACKGROUND

For application sites, such as remote villages, islands, mining sites, land or offshore drilling rigs, on-board ships, and the like, reliable power supplies are needed. A microgrid system is an electrical grid having a number of electricity storage or generating devices that may be adapted to service a localized power load. Typically, each microgrid includes a number of assets, for e.g., generator sets, a windmills, solar generation systems, photovoltaic cells, fuel cells, and the like that is used for generating or storing electricity. Each asset includes an asset controller that controls an operation of a corresponding asset.

Further, the asset controllers have several parameters which are tuned at the time of commissioning to provide a default output response. Such parameters are required to remain same through the asset's lifespan. However, the parameters may change over a period of time due to several reasons, such as asset degradation, change in system configuration, etc. Changes in the parameters of the asset controller may lead to an error in an operation of the asset controller, which may in turn lead to an erroneous behavior of a main controller of the microgrid.

CN111585292B describes an island microgrid frequency regulation control method and a service device. The invention can utilize the adaptive and self-learning capabilities of the radial basis function neural network to adjust the model-free adaptive controller parameters of the secondary frequency modulation system according to a certain control period, effectively overcome the controller parameter adjustment problem in microgrid frequency control, and realize adaptive control of the secondary frequency regulation of the microgrid.

### SUMMARY

In an aspect of the present disclosure, a method of automatically tuning an asset controller of an asset associated with a microgrid is provided. The method includes receiving, by a microgrid controller, at least one input parameter from the asset controller. The microgrid controller is communicably coupled with the asset controller. The method also includes receiving, by the microgrid controller, a current output response from the asset controller. The current output response is generated by the asset controller based on the at least one input parameter. The method further includes determining, by the microgrid controller, a default output response based on the at least one input parameter. The method includes comparing, by the microgrid controller, the current output response with the default output response. The method also includes generating, by the microgrid controller, at least one tunable parameter for the asset controller based on at least one of an algorithm and a method-based technology, and a comparison between the current output response and the default output response. The at least one tunable parameter is configured to automatically tune the asset controller. The method further includes transmitting, by the microgrid controller, the at least one tunable parameter to the asset controller to automatically tune the asset controller.

In another aspect of the present disclosure, a microgrid controller associated with a microgrid is provided. The microgrid includes an asset. The microgrid controller is configured to receive at least one input parameter from the asset controller. The microgrid controller is communicably coupled with the asset controller. The microgrid controller is also configured to determine a default output response based on the at least one input parameter. The microgrid controller is further configured to receive a current output response from the asset controller. The current output response is generated by the asset controller based on the at least one input parameter. The microgrid controller is configured to compare the current output response with the default output response. The microgrid controller is also configured to generate at least one tunable parameter for the asset controller based on at least one of an algorithm and a method-based technology, and a comparison between the current output response and the default output response. The at least one tunable parameter is configured to automatically tune the asset controller. The microgrid controller is further configured to transmit the at least one tunable parameter to the asset controller to automatically tune the asset controller.

Other features and aspects of this disclosure will be apparent from the following description and the accompanying drawings.

### BRIEF DESCRIPTION OF THE DRAWINGS

FIG. 1 is a block diagram of a microgrid, in accordance with an example of the present disclosure;

FIG. 2 is a flowchart depicting a process of automatically tuning an asset controller of an asset associated with the microgrid of FIG. 1, in accordance with an example of the present disclosure; and

FIG. 3 is a flowchart depicting a method of automatically tuning the asset controller of the asset associated with the microgrid of FIG. 1, in accordance with an example of the present disclosure.

### DETAILED DESCRIPTION

Wherever possible, the same reference numbers will be used throughout the drawings to refer to the same or like parts.

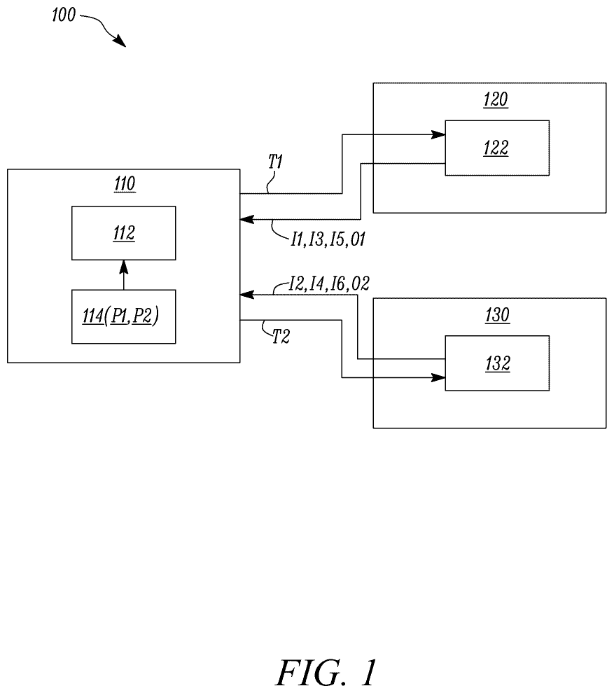

Referring to FIG. 1, a schematic block diagram of a microgrid 100 is illustrated, in accordance with an example of the present disclosure. The microgrid 100 may include an electrical grid having a number of electricity generating devices and/or electricity storage devices that may be adapted to service a localized power load.

The microgrid 100 includes an asset 120, 130. Specifically, the microgrid 100 includes a first asset 120 and a second asset 130. The asset 120 is hereinafter interchangeably referred to as “first asset 120”. The asset 130 is hereinafter interchangeably referred to as “second asset 130”. The microgrid 100 may include any number of assets, however only two assets i.e., the first asset 120, and the second asset 130 are shown herein for exemplary purposes. In an example, the asset 120, 130 includes a renewable energy asset and/or a non-renewable energy asset. Further, in an example, the asset 120, 130 may include a generator set, a fuel cell, a solar generation system, a wind generation system, a photovoltaic cell, a utility grid, and/or an energy storage system. The assets 120, 130 may be of the same type or of different types.

The first asset 120 includes an asset controller 122. Further, the second asset 130 includes an asset controller 132. The asset controller 122 may be hereinafter interchangeably referred to as “the first asset controller 122”. The asset controllers 132 may be hereinafter interchangeably referred to as “the second asset controller 132”.

The microgrid 100 includes a microgrid controller 110. The microgrid controller 110 includes one or more memories 112. The memories 112 may include any means of storing information, including a hard disk, an optical disk, a floppy disk, read only memory (ROM), random access memory (RAM), programmable ROM (PROM), electrically erasable PROM (EEPROM), or other computer-readable memory media known to people skilled in the art.

The microgrid controller 110 also includes one or more processors 114 communicably coupled to the one or more memories 112. It should be noted that the one or more processors 114 may embody a single microprocessor or multiple microprocessors for receiving various input signals and generating output signals. Numerous commercially available microprocessors may perform the functions of the one or more processors 114. Each processor 114 may include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor 114 may include one or more components that may be operable to execute computer executable instructions or computer code that may be stored and retrieved from the one or more memories 112.

The microgrid controller 110 is communicably coupled with the asset controller 122, 132. The microgrid controller 110 receives one or more input parameters I1, I2 from the asset controller 122, 132. The one or more input parameters I1, I2 relate to the asset 120, 130 and is received by the asset controller 122, 132. Specifically, the one or more input parameters I1 relate to input parameters associated with the first asset 120 that is received by the asset controller 122. Further, the one or more input parameters I2 relates to input parameters associated with the second asset 130 that is received by the asset controller 132.

In an example, the one or more input parameters I1, I2 include a response time associated with the asset 120, 130, a rise time associated with the asset 120, 130, an overshoot associated with the asset 120, 130, a settling time associated with the asset 120, 130, a steady state error of voltage associated with the asset 120, 130, a frequency associated with the asset 120, 130, an active power associated with the asset 120, 130, and/or a reactive power associated with the asset 120, 130. It should be noted that the one or more input parameters I1, I2 are based on a type of the asset 120, 130. Accordingly, different types of assets may have different input parameters. Further, the one or more input parameters I1, I2 may include any other input parameter associated with the corresponding asset 120, 130.

The microgrid controller 110 determines a default output response based on the one or more input parameters I1, I2. Specifically, the memories 112 of the microgrid controller 110 store a number of default output responses corresponding to a number of the one or more input parameters I1, I2. Further, the processors 114 determine the default output response by mapping the one or more input parameters I1, I2 from the asset controller 122, 132 with the number of default output responses retrieved from the memories 112.

The microgrid controller 110 also receives a current output response I3, I4 from the asset controller 122, 132. The current output response I3, I4 is generated by the asset controller 122, 132 based on the one or more input parameters I1, I2. Specifically, the current output response I3 relates to output responses associated with the first asset 120 that are generated by the asset controller 122. Further, the current output response I4 relates to output responses associated with the second asset 130 that are generated by the asset controller 132. It should be noted that the current output response I3, I4 is based on the type of the asset 120, 130. Accordingly, different types of assets may have different current output response I3, I4. In an example, each of the current output response I3, I4 and the default output response is defined in terms of a proportional gain, an integral gain, and/or a derivative gain.

Further, the microgrid controller 110 compares the current output response I3, I4 with the default output response. Specifically, the processors 114 may determine if the current output response I3, I4 is same as the default output response or if the current output response I3, I4 is different from the default output response.

The microgrid controller 110 generates one or more tunable parameters T1, T2 for the asset controller 122, 132 based on an algorithm and/or a method-based technology, and a comparison between the current output response I3, I4 and the default output response. Specifically, if the current output response I3, I4 is different from the default output response, the microgrid controller 110 generates the one or more tunable parameters T1, T2 for the asset controller 122, 132. The one or more tunable parameters T1, T2 automatically tunes the asset controller 122, 132. Further, the tunable parameter T1 is associated with the first asset 120 and the tunable parameter T2 is associated with the second asset 130. The one or more tunable parameters T1, T2 may correct the real-time/current output response of the asset controller 122, 132 so that the real-time/current output response corresponds to the default output response.

In an example, the microgrid controller 110 further receives one or more variable parameters I5, I6 associated with the asset 120, 130 to generate the one or more tunable parameters T1, T2 for the asset controller 122, 132. In an example, the one or more variable parameters I5, I6 include a loading condition associated with the asset 120, 130 and/or an environmental condition associated with the asset 120, 130. In such examples, the one or more tunable parameters T1, T2 are generated based on the algorithm and/or the method-based technology, the comparison between the current output response I3, I4 and the default output response, and the one or more variable parameters I5, I6. In an example, the loading condition may include a weight or a torque experienced by the asset 120, 130. In an example, the environmental condition may include a temperature and/or a humidity at a location of the asset 120, 130. In some examples, the variable parameters I5, I6 may be received from the corresponding assets 120, 130 or from a central control system associated with the microgrid 100.

It should be noted that the asset controller 122, 132 may use any algorithm and/or the method-based technology to generate the one or more tunable parameters T1, T2, without any limitations. In some examples, the algorithm and/or the method-based technology includes an artificial neural network method, a machine learning technique, and/or a rule-based approach, without limiting the scope of the present disclosure.

The microgrid controller 110 transmits the one or more tunable parameters T1, T2 to the asset controller 122, 132 to automatically tune the asset controller 122, 132. In an example, the microgrid controller 110 transmits the one or more tunable parameters T1, T2 to the asset controller 122, 132 while the asset 120, 130 and the asset controller 122, 132 are operating.

In one example, the microgrid controller 110 determines whether an error value E1 between the current output response I3, I4 and the default output response is greater than a predefined error limit P1. The predefined error limit P1 is stored within the memories 112 of the microgrid controller 110. Further, the microgrid controller 110 transmits the one or more tunable parameters T1, T2 to the asset controller 122, 132 if the error value E1 is greater than the predefined error limit.

In another example, the microgrid controller 110 determines whether a number of operating hours O1, O2 of the asset 120, 130 is more than a predefined number of operating hours P2. In an example, the number of operating hours O1, O2 of the asset 120, 130 may be received from the asset controller 122, 132. The predefined number of operating hours O1, O2 is stored within the memories 112 of the microgrid controller 110. The microgrid controller 110 transmits the one or more tunable parameters T1, T2 to the asset controller 122, 132 if the number of operating hours O1, O2 of the asset 120, 130 are more than the predefined number of operating hours P2.

In an example, the microgrid controller 110 receives an updated current output response after transmitting the one or more tunable parameters T1, T2 to the asset controller 122, 132. The updated current output response is generated by the asset controller 122, 132 based on the one or more input parameters I1, I2.

In an example, the microgrid controller 110 compares the updated current output response with the default output response. Further, the microgrid controller 110 evaluates a performance of the asset controller 122, 132 based on a comparison between the updated current output response and the default output response. If the updated current output response does not match with the default output response, the microgrid controller 110 may further generate one or more tunable parameters T1, T2 to tune the asset controller 122, 132.

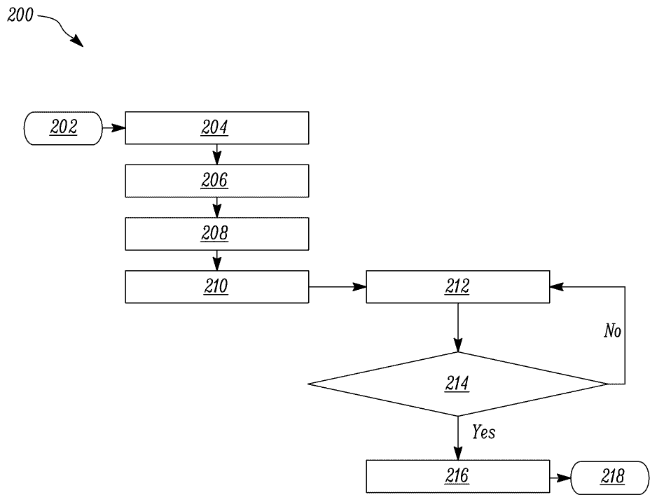

Referring now to FIG. 2, a flowchart depicting a process 200 of automatically tuning the asset controller 122, 132 of the asset 120, 130 associated with the microgrid 100 of FIG. 1 is illustrated, in accordance with an example of the present disclosure.

Referring to FIGS. 1 and 2, the process 200 may be stored in the one or more memories 112 of the microgrid controller 110 and retrieved for execution by the one or more processors 114 of the microgrid controller 110.

At a block 202, the process 200 starts operation. At a block 204, the microgrid controller 110 identifies the asset controller 122, 132 of the asset 120, 130. At a block 206, the microgrid controller 110 receives the one or more input parameters I1, I2 from the asset controller 122, 132. At a block 208, the microgrid controller 110 determines the default output response based on the one or more input parameters I1, I2. At a block 210, the microgrid controller 110 receives the current output response I3, I4 from the asset controller 122, 132. At a block 212, the microgrid controller 110 generates the one or more tunable parameters T1, T2 for the asset controller 122, 132 based on the algorithm and/or the method-based technology, and the comparison between the current output response I3, I4 and the default output response. At a block 214, the microgrid controller 110 determines if the error value E2 is more than the predefined error limit P1 or the operating hours O1, O2 are more than the predefined number of the operating hours P2.

At the block 214, if the microgrid controller 110 determines that the error value E2 is less than the predefined error limit P1 and/or the operating hours O1, O2 are less than the predefined number of the operating hours P2, the process 200 moves back to the block 210.

However, at the block 214, if the microgrid controller 110 determines that the error value E2 is more than the predefined error limit P1 and/or the operating hours O1, O2 are more than the predefined number of the operating hours P2, the process 200 moves to a block 216.

At the block 216, the microgrid controller 110 transmits the one or more tunable parameters T1, T2 to the asset controller 122, 132 to automatically tune the asset controller 122, 132. At a block 218, the process 200 ends operation.

It may be noted that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure as defined in the appended claims.

### INDUSTRIAL APPLICABILITY

The present disclosure describes the microgrid controller 110 associated with the microgrid 100. The microgrid controller 110 generates the one or more tunable parameters T1, T2 for each asset controller 122, 132, and also automatically tunes the asset controller 122, 132 as and when needed by transmitting the generated tunable parameters T1, T2. The autotuning of the asset controller 122, 132 by the microgrid controller 110 may eliminate a requirement for manual intervention to tune the asset controllers 122, 132 if there is a deviation in the current output response I3, I4 of the asset controller 122, 132 from the default output response. The autotuning of the asset controller 122, 132 may provide desired proportional, integral, and/or derivative gain that matches the original response of the asset controller 122, 132.

The microgrid controller 110 may maintain a stable and desired performance of the asset 120, 130 by continuously generating the one or more tunable parameters T1, T2 and transmitting the one or more tunable parameters T1, T2 as and when required. Further, the microgrid controller 110 also considers the variable parameters I5, I6 associated with the assets 120, 130 while generating the one or more tunable parameters T1, T2. As the assets 120, 130 and the asset controllers 122, 132 may behave differently under varying loads or environmental conditions, consideration of the variable parameters I5, I6 such as the loading and the environmental conditions, may improve an accuracy of determining the one or more tunable parameters T1, T2.

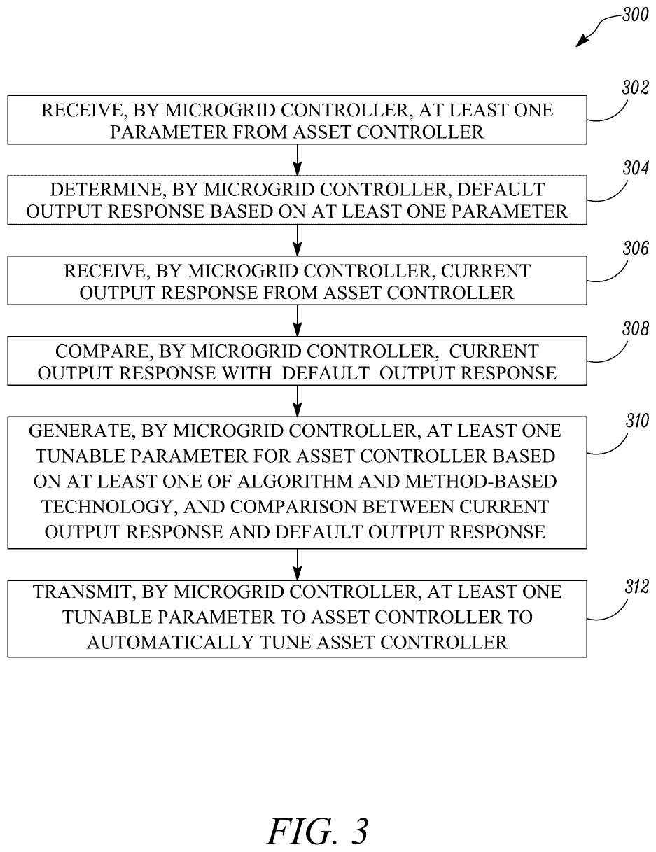

FIG. 3 is a flowchart depicting a method 300 of automatically tuning the asset controller 122, 132 of the asset 120, 130 associated with the microgrid 100 is illustrated, in accordance with an example of the present disclosure.

Referring now to FIGS. 1 and 3, in an example, the asset 120, 130 includes the renewable energy asset and/or the non-renewable energy asset. At step 302, the microgrid controller 110 receives the one or more input parameters I1, I2 from the asset controller 122, 132. The microgrid controller 110 is communicably coupled with the asset controller 122, 132.

At step 304, the microgrid controller 110 determines the default output response based on the one or more input parameters I1, I2.

At step 306, the microgrid controller 110 receives the current output response I3, I4 from the asset controller 122, 132. The current output response I3, I4 is generated by the asset controller 122, 132 based on the one or more input parameters I1, I2.

At step 308, the microgrid controller 110 compares the current output response I3, I4 with the default output response.

At step 310, the microgrid controller 110 generates the one or more tunable parameters T1, T2 for the asset controller 122, 132 based on the algorithm and/or the method-based technology, and the comparison between the current output response I3, I4 and the default output response. The one or more tunable parameters T1, T2 automatically tune the asset controller 122, 132. Each of the current output response I3, I4 and the default output response is defined in terms of the proportional gain, the integral gain, and/or the derivative gain

At step 312, the microgrid controller 110 transmits the one or more tunable parameters T1, T2 to the asset controller 122, 132 to automatically tune the asset controller 122, 132.

In an example, the method 300 further includes a step (not shown) at which the microgrid controller 110 determines whether the error value E1 between the current output response I3, I4 and the default output response is greater than the predefined error limit. The method 300 further includes a step (not shown) at which the microgrid controller 110 transmits the one or more tunable parameters T1, T2 to the asset controller 122, 132 if the error value E1 is greater than the predefined error limit.

In an example, method 300 further includes a step (not shown) at which the microgrid controller 110 determines whether the number of operating hours O1, O2 of the asset 120, 130 is more than the predefined number of operating hours P2. The method 300 further includes a step (not shown) at which the microgrid controller 110 transmits the one or more tunable parameters T1, T2 to the asset controller 122, 132 if the number of operating hours O1, O2 of the asset 120, 130 are more than the predefined number of operating hours P2.

The method 300 further includes a step (not shown) at which the microgrid controller 110 transmits the one or more tunable parameters T1, T2 to the asset controller 122, 132 while the asset 120, 130 and the asset controller 122, 132 are operating.

The method 300 further includes a step (not shown) at which the microgrid controller 110 receives the updated current output response after transmitting the one or more tunable parameters T1, T2 to the asset controller 122, 132. The updated current output response is generated by the asset controller 122, 132 based on the one or more input parameters I1, I2. The method 300 further includes a step (not shown) at which the microgrid controller 110 compares the updated current output response with the default output response. The method 300 further includes a step (not shown) at which the microgrid controller 110 evaluates the performance of the asset controller 122, 132 based on the comparison between the updated current output response and the default output response.

The method 300 further includes a step (not shown) at which the microgrid controller 110 receives the one or more variable parameters I5, I6 associated with the asset 120, 130 for generating the one or more tunable parameters T1, T2 for the asset controller 122, 132. The one or more variable parameters I5, I6 includes the loading condition associated with the asset 120, 130 and/or the environmental condition associated with the asset 120, 130.

It should be noted that the steps 302, 304, 306, 308, 310, 312 of the method 300 may be performed in a sequence that is different from that explained in relation to FIG. 3. Further, various steps 302, 304, 306, 308, 310, 312 can be performed together.

The method 300 may increase a flexibility to autotune the parameters of the asset controller 122, 132 without interrupting regular operations of the asset 120, 130 or the microgrid 100.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. A method of automatically tuning an asset controller of an asset associated with a microgrid, the method comprising:
receiving, by a microgrid controller, at least one input parameter from the asset controller, wherein the microgrid controller is communicably coupled with the asset controller;
determining, by the microgrid controller, a default output response based on the at least one input parameter;
receiving, by the microgrid controller, a current output response from the asset controller, wherein the current output response is generated by the asset controller based on the at least one input parameter;
comparing, by the microgrid controller, the current output response with the default output response;
generating, by the microgrid controller, at least one tunable parameter for the asset controller based on at least one of an algorithm and a method-based technology, and a comparison between the current output response and the default output response, wherein the at least one tunable parameter is configured to automatically tune the asset controller; and
transmitting, by the microgrid controller, the at least one tunable parameter to the asset controller to automatically tune the asset controller.

2. The method of claim 1, wherein each of the current output response and the default output response is defined in terms of at least one of a proportional gain, an integral gain, and a derivative gain.

3. The method of claim 1 further comprising:
determining, by the microgrid controller, whether an error value between the current output response and the default output response is greater than a predefined error limit; and
transmitting, by the microgrid controller, the at least one tunable parameter to the asset controller if the error value is greater than the predefined error limit.

4. The method of claim 1 further comprising:
determining, by the microgrid controller, whether a number of operating hours of the asset is more than a predefined number of operating hours; and
transmitting, by the microgrid controller, the at least one tunable parameter to the asset controller if the number of operating hours of the asset is more than the predefined number of operating hours.

5. The method of claim 1 further comprising transmitting, by the microgrid controller, the at least one tunable parameter to the asset controller while the asset and the asset controller are operating.

6. The method of claim 1 further comprising:
receiving, by the microgrid controller, an updated current output response after transmitting the at least one tunable parameter to the asset controller, wherein the updated current output response is generated by the asset controller based on the at least one input parameter;
comparing, by the microgrid controller, the updated current output response with the default output response; and
evaluating, by the microgrid controller, a performance of the asset controller based on a comparison between the updated current output response and the default output response.

7. The method of claim 1, wherein the asset includes at least one of a renewable energy asset and a non-renewable energy asset.

8. The method of claim 1, wherein the asset includes at least one of a generator set, a fuel cell, a solar generation system, a wind generation system, a photovoltaic cell, a utility grid, and an energy storage system.

9. The method of claim 1 further comprising receiving, by the microgrid controller, one or more variable parameters associated with the asset for generating the at least one tunable parameter for the asset controller, wherein the one or more variable parameters includes at least one of a loading condition associated with the asset and an environmental condition associated with the asset.

10. The method of claim 1, wherein at least one of the algorithm and the method-based technology includes any one of an artificial neural network method, a machine learning technique, and a rule-based approach.

11. A microgrid controller associated with a microgrid, wherein the microgrid includes an asset, the microgrid controller being configured to:
receive least one input parameter from the asset controller, wherein the at least one input parameter relates to at least one input parameter that is received by the asset controller, and wherein the microgrid controller is communicably coupled with the asset controller;
determine a default output response based on the at least one input parameter;
receive a current output response from the asset controller, wherein the current output response is generated by the asset controller based on the at least one input parameter;
compare the current output response with the default output response;
generate at least one tunable parameter for the asset controller based on at least one of an algorithm and a method-based technology, and a comparison between the current output response and the default output response, wherein the at least one tunable parameter is configured to automatically tune the asset controller; and
transmit the at least one tunable parameter to the asset controller to automatically tune the asset controller.

12. The microgrid controller of claim 11, wherein each of the current output response and the default output response is defined in terms of at least one of a proportional gain, an integral gain, and a derivative gain.

13. The microgrid controller of claim 11 further configured to:
determine whether an error value between the current output response and the default output response is greater than a predefined error limit; and
transmit the at least one tunable parameter to the asset controller if the error value is greater than the predefined error limit.

14. The microgrid controller of claim 11 further configured to:
determine whether a number of operating hours of the asset is more than a predefined number of operating hours; and
transmit the at least one tunable parameter to the asset controller if the number of operating hours of the asset is more than the predefined number of operating hours.

15. The microgrid controller of claim 11 further configured to transmit the at least one tunable parameter to the asset controller while the asset and the asset controller are operating.

16. The microgrid controller of claim 11 further configured to:
receive an updated current output response after transmitting the at least one tunable parameter to the asset controller, wherein the updated current output response is generated by the asset controller based on the at least one input parameter;
compare the updated current output response with the default output response; and
evaluate a performance of the asset controller based on a comparison between the updated current output response and the default output response.

17. The microgrid controller of claim 11, wherein the asset includes at least one of a renewable energy asset and a non-renewable energy asset.

18. The microgrid controller of claim 11, wherein the at least one input parameter includes at least one of a response time associated with the asset, a rise time associated with the asset, an overshoot associated with the asset, a settling time associated with the asset, a steady state error of voltage associated with the asset, a frequency associated with the asset, an active power associated with the asset, and a reactive power associated with the asset.

19. The microgrid controller of claim 11 further configured to receive one or more variable parameters associated with the asset to generate the at least one tunable parameter for the asset controller.

20. The microgrid controller of claim 19, wherein the one or more variable parameters includes at least one of a loading condition associated with the asset and an environmental condition associated with the asset.
